(19) United States
(12) Patent Application Publication
(10) Pub. No.: US 2020/0406472 A1
(43) Pub. Date: Dec. 31, 2020

(54) DEVICE AND METHOD FOR MEASURING FORCE

(71) Applicants: SORBONNE UNIVERSITE, PARIS (FR); CENTRE NATIONAL DE LA RECHERCHE SCIENTIFIQUE, PARIS (FR)

(72) Inventors: Sinan HALIYO, PARIS (FR); Antoine WEILL-DUFLOS, AUFFARGIS (FR); Vincent HAYWARD, PARIS (FR); Stéphane REGNIER, BOIS-COLOMBES (FR); Olga PETIT, PARIS (FR)

(21) Appl. No.: 16/960,718

(22) PCT Filed: Jan. 10, 2019
(86) PCT No.: PCT/EP2019/050591

§ 371 Date: Sep. 10, 2020

(30) Foreign Application Priority Data
Jan. 11, 2018 (FR) 1850231

(51) Int. Cl. B25J 13/08; G01L 1/08

(52) U.S. Cl. CPC B25J 13/085; G01L 1/086; B25J 13/088

(57) ABSTRACT

The present invention concerns a device (101, 102, 103, 104) for measuring force, comprising: a movable member (1); guide means (2) for guiding the movable member along at least one degree of freedom; position measuring means (3) for measuring the position of the movable member; at least one actuator (4) for applying an actuator force (7) to the movable member; a control system (5), arranged to send a control signal to the at least one actuator, the actuator force depending on the control signal, the control system being arranged to modify the control signal according to a measurement of the position of the movable member by the position measuring means; force measuring means (6) arranged to provide, from the control signal sent by the control system to the at least one actuator, a value of a force to be measured (8) being applied to the movable member and separate from the actuator force. The means for guiding the movable member exert no return force on the movable member along the at least one degree of freedom.

### TECHNICAL FIELD

The present invention relates to a device for measuring force. It also relates to a method for measuring force.

Such a device allows a user to measure a force. The field of the invention is more particularly, but non-limitatively, that of the measurement of attractive and/or repulsive action-at-a-distance forces or those having rapid variation.

### STATE OF THE PRIOR ART

A great many systems for measuring force are known according to the state of the art for measuring small forces (typically from millinewton to newton).

Force measurement is carried out conventionally by means of the deformation of a flexible element of known stiffness (spring, piezoceramic, etc.) such as an AFM or a piezoelectric sensor.

This state of the art generally poses several problems:
possibility of effective measurement of “attractive forces”,
possibility of effective measurement of forces with large dynamic variations,
precision and resolution of the measurement,
available range of stiffness,
bulkiness and/or weight of the measuring device.

The aim of the present invention is to solve at least one of the aforementioned problems or to succeed in solving several of them at the same time without the solution of one problem exacerbating another of these problems.

### DISCLOSURE OF THE INVENTION

This aim is achieved with a device for measuring force, comprising:
a movable member,
means for guiding the movable member within at least one degree of freedom,
position measuring means arranged for measuring a position of the movable member within the at least one degree of freedom,
at least one actuator, separate from the guiding means, and arranged for exerting an actuating force on the movable member within the at least one degree of freedom,
a control system, arranged and/or programmed for sending a control signal to the at least one actuator, the actuating force depending on the control signal, the control system being arranged to modify the control signal as a function of a measurement of the position of the movable member by the position measuring means,
force measuring means arranged and/or programmed for supplying, based on the control signal sent by the control system to the at least one actuator, a value of a force to be measured acting on the movable member and separate from the actuating force.

The means for guiding the movable member within the at least one degree of freedom preferably do not exert a restoring force on the movable member within the at least one degree of freedom.

The control system may be arranged and/or programmed for:
controlling the position of the movable member at a fixed position regardless of the value of the force to be measured, or
fixing a value of the actuating force as a function of the position of the movable member.

The guiding means are preferably guiding means that are contactless with respect to the movable member.

The position measuring means are preferably measuring means that are contactless with respect to the movable member.

The position measuring means preferably do not exert a restoring force on the movable member within the at least one degree of freedom.

Each actuator preferably does not come into contact with the movable member.

The movable member preferably does not come into contact with any other component of the device.

The device according to the invention may comprise one actuator per degree of freedom in translation.

The at least one degree of freedom may comprise:
only one degree of freedom in translation, (or 2 or 3 degrees of freedom in translation, preferably orthogonal), and/or
only one degree of freedom in rotation (or preferably as many degrees of freedom in rotation as there are degrees of freedom in translation, each degree of freedom in rotation preferably being a degree of freedom of rotation about one of the axes of displacement of one of the degrees of freedom in translation) or no degree of freedom in rotation.

Preferably, the guiding means comprise or consist of air cushion guiding means.

Preferably, the position measuring means comprise or consist of an optical sensor.

Preferably, each actuator comprises or consists of an electromagnetic actuator, preferably of the “voice coil” type.

According to yet another aspect of the invention, a method for measuring force is proposed, comprising:
guiding, by means of guiding means, a movable member within at least one degree of freedom,
measuring the position of the movable member within the at least one degree of freedom by means of position measuring means,
exerting an actuating force on the movable member within the at least one degree of freedom, by means of at least one actuator different from the guiding means,
sending a control signal by means of a control system to the at least one actuator, the actuating force depending on the control signal, the control system modifying the control signal as a function of the position measurement of the movable member by the position measuring means,
a force measurement supplying, based on the control signal sent by the control system to the at least one actuator, a value of a force to be measured acting on the movable member and separate from the actuating force.

The means for guiding the movable member within the at least one degree of freedom preferably do not exert a restoring force on the movable member within the at least one degree of freedom.

The control system may:
control the position of the movable member at a fixed position regardless of the value of the force to be measured, or
fix a value of the actuating force as a function of the position of the movable member.

The guiding means preferably guide the movable member without contact with the movable member.

The position measuring means preferably measure the position of the movable member without contact with the movable member.

The position measuring means preferably do not exert a restoring force on the movable member within the at least one degree of freedom.

The at least one actuator preferably exerts the actuating force on the movable member without contact with the movable member.

The movable member preferably does not come into contact with any other component of the device implementing the method.

For implementation, the method according to the invention may comprise one actuator per degree of freedom in translation.

The at least one degree of freedom may comprise:
only one degree of freedom in translation, (or 2 or 3 degrees of freedom in translation, preferably orthogonal), and/or
only one degree of freedom in rotation (preferably as many degrees of freedom in rotation as there are degrees of freedom in translation, each degree of freedom in rotation preferably being a degree of freedom of rotation about one of the axes of displacement of one of the degrees of freedom in translation) or no degree of freedom in rotation.

Preferably, the guiding means comprise or consist of air cushion guiding means.

Preferably, the position measuring means comprise or consist of an optical sensor.

Preferably, each actuator comprises or consists of an electromagnetic actuator, preferably of the “voice coil” type.

### DESCRIPTION OF THE FIGURES AND EMBODIMENTS

Other advantages and features of the invention will become apparent on reading the detailed description of implementations and embodiments which are in no way limitative, and the following attached drawings:

FIG. 1 is a diagrammatic view of a first embodiment of device 101 according to the invention,

FIG. 2 is a diagrammatic view of a second embodiment of device 102 according to the invention,

FIG. 3 is a perspective view of the second embodiment of device 102 according to the invention,

FIG. 4 is a perspective view of a third embodiment of device 103 according to the invention,

FIG. 5 is a perspective view of a fourth embodiment of device 104 according to the invention.

As these embodiments are in no way limitative, variants of the invention can be considered in particular comprising only a selection of the characteristics described or illustrated hereinafter, in isolation from the other characteristics described or illustrated (even if this selection is isolated within a phrase containing these other characteristics), if this selection of characteristics is sufficient to confer a technical advantage or to differentiate the invention with respect to the state of the prior art. This selection comprises at least one, preferably functional, characteristic without structural details, and/or with only a part of the structural details if this part alone is sufficient to confer a technical advantage or to differentiate the invention with respect to the state of the prior art.

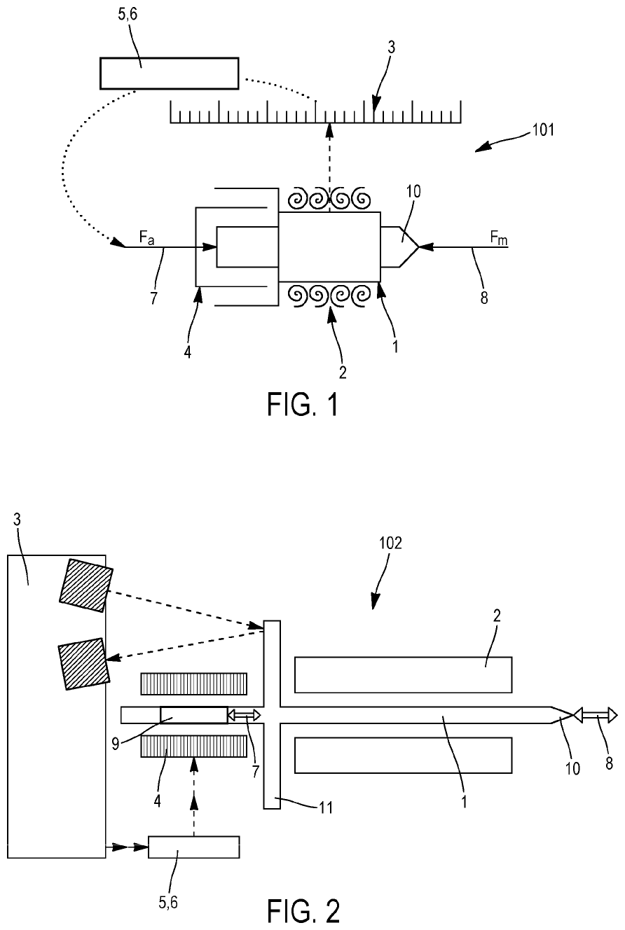

A first embodiment of device 101 according to the invention implementing an embodiment of the method according to the invention will be described first, with reference to FIG. 1.

This embodiment makes it possible to measure surface forces such as van der Waals forces, electrostatic forces, or capillary forces.

The device 101 does not have apparent stiffness. It is a single mass.

The force measuring device 101 comprises a movable member 1 that is able to move, and is also called probe 1 or movable element 1 hereinafter.

The device 101 is a device 101 for measuring force by force compensation, and does not comprise any intrinsic physical stiffness on the movable member 1.

To limit its inertia, the movable member 1 has a mass less than 50 grams, preferably less than 10 grams, in this example less than 5 grams.

This embodiment uses a levitated probe (member 1), that is contactless with respect to the rest of the device 101 (including the frame of the device 101).

The device 101 has a control loop principle of force measurement.

The device 101 comprises means 2 for guiding the movable member 1 arranged to guide or constrain the movements of the movable member 1 within at least one degree of freedom, preferably including at least one degree of freedom in translation.

The movable member 1 has, at one of its ends along the or one of the degree(s) of freedom in translation, a mandrel 10 making it possible to arrange an element (electrically charged and/or magnetized and/or pointed forming an almost point mechanical contact, etc.) depending on the nature of the external force 8 to be measured.

Hereinafter, each degree of freedom of the movable member 1 will simply be called “degree of freedom”, without reference to the movable member 1.

The guiding means 2 constrain any movement of the movable member 1 within this at least one degree of freedom.

The device 101 comprises position measuring means 3 arranged for measuring a position of the movable member 1 within the at least one degree of freedom, preferably with a resolution of at least 0.1 μm.

The device 101 comprises at least one actuator 4, different from the guiding means 2, arranged for exerting an actuating force 7 on the movable member 1 within the at least one degree of freedom.

It is indeed the actuator or set of actuators 4 that is arranged for exerting the actuating force 7. This actuating force 7 may be broken down into several (2 or 3) components orthogonal to one another.

The device 101 only comprises one actuator 4 per degree of freedom in translation.

The actuating force 7 has as many components orthogonal to one another as the movable member 1 has degree(s) of freedom in translation.

Each degree of freedom in translation is associated with an actuator 4.

Each actuator 4 is arranged for exerting, on the movable member 1, a component of the actuating force 7 parallel to the degree of freedom in translation to which this actuator 4 is associated.

The device 101 comprises a control system 5, arranged and/or programmed for sending a control signal to the at least one actuator 4, the actuating force 7 depending on the control signal, the control system 5 being arranged for modifying the control signal as a function of a measurement of position of the movable member 1 by the position measuring means 3.

This control signal may comprise several components. For example, in an embodiment with several actuators 4, the control system 5 is arranged for sending one component of the control signal per actuator 4. There is therefore one component of the control signal per actuator 4 and therefore per component of the actuating force 7.

Each of the means of this embodiment of the device according to the invention are technical means.

The control system 5 utilises a control algorithm.

The control system 5 only comprises technical means.

The control system 5 comprises at least one computer, a central processing unit or computing unit, an analogue electronic circuit (preferably dedicated), a digital electronic circuit (preferably dedicated), and/or a microprocessor (preferably dedicated), and/or software means.

The device 101 is connected to a circuit board supplying a solution for testing different control schemes using software that synthesizes control schemes. An integrated converter generates the code that is then executed in real time on the control system 5.

The movable member 1 is controlled in position by means of the control system 5, which is of the Proportional Integral Derivative (PID) type. The proportional part controls the dynamic response of the device 101 and its capacity for measuring rapid phenomena, the integral part controls the accuracy of the measurements as well as the sensitivity to small forces, and the derivative part stabilizes the device 101.

Control is implemented on the control system 5 in real time. This control system 5 is made up of a computer running under Linux with a real-time kernel with RTAI. A frequency of 20 kHz is attainable. In other variants, the control algorithm of the control system 8 is implemented on an FPGA (this solution reaches sampling frequencies of several hundred kilohertz) or on an analogue control (the device 101 then becomes a continuous system and the problems of delay of the discrete systems are eliminated).

The device 101 comprises force measuring means 6 arranged and/or programmed for supplying, on the basis of the control signal sent by the control system 5 to the at least one actuator 4, a value of a force to be measured 8 acting on the movable member 1 and separate from the actuating force 7.

The force to be measured 8 can be broken down into several (2 or 3) components orthogonal to one another.

The measuring means 6 only comprise technical means.

The measuring means 6 comprise at least one computer, a central processing unit or computing unit, an analogue electronic circuit (preferably dedicated), a digital electronic circuit (preferably dedicated), and/or a microprocessor (preferably dedicated), and/or software means.

The measuring means 6 are computing means.

The means 2 for guiding the movable member 1 within the at least one degree of freedom do not exert a restoring force on the movable member 1 in each degree of freedom among the at least one degree of freedom.

The means 2 for guiding the movable member 1 within the at least one degree of freedom do not have stiffness (intrinsic physical stiffness) or resistance to displacement of the movable member 1 within each degree of freedom among the at least one degree of freedom relative to the guiding means 2.

The guiding means 2 have, for each degree of freedom among the at least one degree of freedom, a natural pulsation of zero.

For the guiding means 2 and the movable member 1 considered alone, there is no state or position of equilibrium of the movable member 1 relative to the guiding means 2.

The guiding means 2 are guiding means that are contactless with respect to the movable member 1.

The guiding means 2 may comprise multiple variants, such as guidance by air cushion, a magnetic levitation system, and/or electromagnetic suspension.

In the present description, a first element is described as “contactless with respect to” a second element if no solid and/or liquid connects this first element to the second element. Conversely, these two elements are considered “contactless” even if they are connected by vacuum or a gas, for example such as air.

The position measuring means 3 are measuring means that are contactless with respect to the movable member 1.

The measuring means 3 may comprise multiple variants, such as a system for remote measurement by laser beam, an interferometric system, a capacitive system, a magnetic induction system, an SIDS interferometer, a proximity sensor (for example Sharp GP2S60), a sensor (for example ILD1420-10 from Micro-Epsilon), and/or an optical rule.

The position measuring means 3 do not exert a restoring force on the movable member 1 within the at least one degree of freedom.

Each actuator 4 does not come into contact with the movable member 1.

Each actuator 4 may comprise multiple variants, such as an electromagnetic and/or electrostatic actuating system.

The at least one actuator 4 does not have intrinsic physical stiffness relative to the movable member 1, but has only (as will be seen later) a stiffness produced artificially via the control system 5, which can even be set to a value of zero.

The movable member 1 does not come into contact with any other component of the device 101.

Thus, according to the invention:
the absence of any contact with the movable member 1 (to avoid frictional forces),
the absence of restoring force exerted by the guiding means 2 on the movable member 1, (and the absence of restoring force acting on the movable member 1 by any part other than the at least one actuator 4),

makes it possible to eliminate problems of mechanical stiffness and rely entirely on an (electronic) control loop, thus allowing fine control and knowledge of the restoring force.

The simplified operation of the device is shown in FIG. 1. When a force to be measured Fm is applied to the member 1, a displacement of the movable part 1 is measured by the position sensor 3. The position measurement is used by the control system 5 to compensate the force Fm applied to the member 1.

This embodiment of device 101 has a resolution of measurement of the force Fm less than or equal to 0.1 mN, preferably with a frequency of measurement of at least 50 Hz.

There are two variants of this embodiment.

According to a first variant, the control system 5 is arranged and/or programmed to control the position of the movable member 1 at a fixed position regardless of the value of the force to be measured 8.

An example of this first variant will be given, in a case only comprising one degree of freedom in translation (with optionally a single degree of freedom in rotation about the axis of displacement in translation of this degree of freedom in translation).

This example can quite clearly be generalized to two or three spatial dimensions.

In this example of the first variant, the movable member 1 is at a starting position (X=0) for a zero force to be measured 8 (i.e. equal to Fm=0).

In this example of the first variant, the control system 5 utilises a control algorithm (typically using a feedback loop between the position measuring means 3 and the control signal sent to at least actuator 4) arranged for sending, regardless of the force to be measured Fm (also referenced 8 in the figures) acting on the movable member 1, a control signal to at least actuator 4 for maintaining the position of the movable member 1 at its starting position (X=0).

As the measuring means 6 know the actuating force Fa (also referenced Fa in the figures), the measuring means 6 easily deduce Fm as being equal in absolute value to Fa. Fm=−Fa is used for the calculation. Fa is known because it is the force generated via the control signal and the actuator 4, the characteristics of which are rigorously identified.

In this first variant, the actuator or each actuator 4 has zero stiffness. Device 101 according to the invention has an infinite bandwidth. In this first variant, the device according to the invention is said to be “without displacement” or “with zero movement” of the movable element 1 (even if in actual fact the movable element 1 may be excited by a succession of micromovements within the at least one degree of freedom, which are compensated almost simultaneously by the at least one actuator 4).

Owing to this control with zero movement, by means of the control system 5 and the at least one electromagnetic actuator 4, it is possible to know the force Fa opposing the movement of the probe 1, substantially equal in absolute value to the value of the external force Fm that it is desired to measure. This approach makes it possible to measure the value of a force at a precise position in space, without the variation due to deformation of a flexible element, which is useful for measuring action-at-a-distance forces (magnetic, electrostatic, van der Waals, etc.).

This variant is also particularly robust for the case of attractive forces or forces with large dynamic variations, cases in which the sensors according to the state of the art fail, as the measurement according to the state of the art is then contaminated by the mechanical characteristics of the probe (mass, stiffness), as well as the linear form of the restoring force as a function of the displacement, with the parameters of this function imposed by the mechanical characteristics of the arrangement of a sensor according to the state of the art.

Great stability is thus obtained, despite the variations of the external force Fm.

The accuracy and resolution depend solely on the control electronics, but not on any mechanical constraint, and can therefore be controlled and monitored very finely.

The invention therefore has potential applications for measuring action-at-a-distance forces or effects with rapid variations. Such phenomena are encountered for example in microrobotics, in methods of biological injection and in the realization of automated systems.

Typically, measurements of variations of forces are obtained with a bandwidth of up to 300 Hz, which represents a gain of about 20 compared to the state of the art for similar applications.

According to a second variant, the control system 5 is arranged and/or programmed to fix a value of the actuating force 7 as a function of the position of the movable member 1.

An example of this second variant will be given in a case only comprising one degree of freedom in translation (with optionally a single degree of freedom in rotation about the axis of displacement in translation of this degree of freedom in translation).

This example can quite clearly be generalized to two or three spatial dimensions.

In this example of the second variant, the movable member 1 is at a starting position (X=0) for a zero force to be measured 8 (i.e. equal to Fm=0).

In this example of the second variant, the movable member 1 is displaced to a position X≠0 as a function of the force Fm acting thereon, and the control system 5 implements a control algorithm (typically using a feedback loop between the position measuring means 3 and the control signal sent to at least actuator 4) arranged for sending a control signal to at least actuator 4 so as to exert, on the movable member 1, an actuating force Fa the value of which (or the values of its various components) depends on this position X, typically by a law of proportionality between X and Fa (Fa=f(X)) connected by a stiffness K, which, expressed in its simplest form, would be:

Fa=K·X similarly to a spring, but which could also more generally be non-linear, which is not possible to achieve easily with a mechanical component.

It should be noted that in this second variant, the stiffness K is non-zero and may be positive or even negative, which allows yet another case that is not possible with an element with real mechanical stiffness.

In this case, Fm is deduced via the displacement measurement X of the measured probe 1, and knowledge of the function f(X)=Fa, still with, in absolute value, Fa=Fm owing to the absence of parasitic forces. As the measuring means 6 know the actuating force Fa (also referenced 7 in the figures), the measuring means 6 easily deduce Fm as being equal in absolute value to Fa.

Thus, another possibility is use of the invention as a conventional force sensor with deformation (without intrinsic physical stiffness, but with a stiffness produced artificially by the control system 5 and the at least one actuator 4), where the stiffness is supplied by the control of the at least one electromagnetic actuator 4, thus allowing the stiffness value to be fixed at will, including non-linearly or even negatively.

Thus, the method according to the invention implemented by the device 101 comprises:
guiding, by means of the guiding means 2, the movable member 1 within the at least one degree of freedom,
measuring the position of the movable member 1 within the at least one degree of freedom by means of the position measuring means 3,
exerting the actuating force Fa on the movable member 1 within the at least one degree of freedom, by means of the at least one actuator 4 different from the guiding means 2,
sending, by means of the control system 5, the control signal to the at least one actuator 4, the actuating force Fa depending on the control signal, the control system 5 modifying the control signal as a function of the position measurement of the movable member 1 by the position measuring means 3,
a force measurement supplying, by means of the technical means 6 and based on the control signal sent by the control system 5 to the at least one actuator 4, a value of the force to be measured Fm acting on the movable member and separate from the actuating force,
   the means 2 for guiding the movable member 1 not exerting any restoring force on the movable member 1 within the at least one degree of freedom.

The guiding means 2 guide the movable member 1 without contact with the movable member 1.

The position measuring means 3 measure the position of the movable member 1 without contact with the movable member 1.

The position measuring means 3 do not exert a restoring force on the movable member 1 within the at least one degree of freedom.

The at least one actuator 4 exerts the actuating force 7 on the movable member 1 without contact with the movable member 1.

The movable member 1 does not come into contact with any other component of the device 101 implementing the method.

In the first variant described above, the control system 5 controls the position of the movable member 1 at a fixed position regardless of the value of the force to be measured 8.

In the second variant described above, the control system 5 fixes a value of the actuating force 7 as a function of the position of the movable member 1.

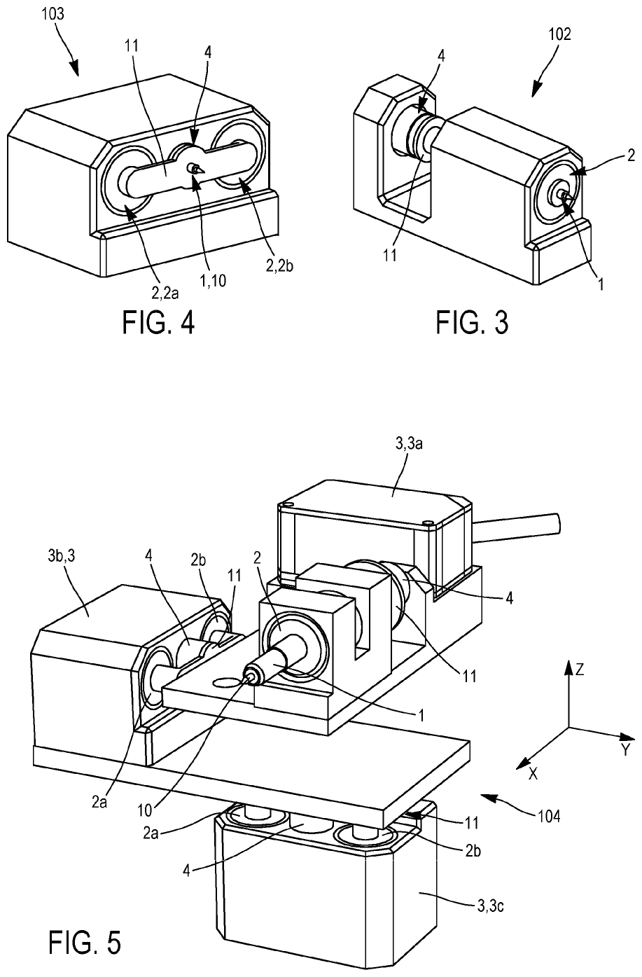

A second embodiment of device 102 according to the invention implementing a method according to the invention will now be described, with reference to FIG. 2 and FIG. 3, but only with respect to its differences relative to the first embodiment 101.

The elements 3, 5, 6, and 9 are not illustrated in FIG. 3 but are present in this embodiment.

This embodiment of device 102 has a measurement range from 0.00044 N to 1 N.

The member 1 is constrained to unidirectional movement.

The at least one degree of freedom only comprises a single degree of freedom in translation, called principal degree of freedom in translation.

The at least one degree of freedom only comprises a single degree of freedom in rotation about an axis of displacement of the degree of freedom in translation.

The means 2 are arranged to keep the member 1 levitated.

The guiding means 2 comprise or consist of air cushion guiding means or guiding means by air bearing, for example having reference S300601 from New Way Air Bearings.

For this “freely rotating” version, a single air bearing 2 is used in the guiding means. The actuator 4 is then aligned with the bearing 2.

The position measuring means 3 comprise or consist of an optical sensor.

The means 3 comprise a laser triangulation sensor.

The means 3 comprise an ILD1420-10 sensor from Micro-Epsilon.

The member 1 comprises a reflective element 11 (typically a metal disk) arranged to reflect the position measurement light beam emitted by the means 3.

The actuator 4 (associated with the principal degree of freedom in translation) comprises or consists of an electromagnetic actuator, of the “voice coil” type comprising a coil or solenoid or electromagnet, for example having reference NCC01-04-001-1X from H2 W technologies.

The use of a “voice coil” for actuation provides contactless linear operation. This technical solution develops a force proportional to the current applied to the coil. Moreover, the mass and the size are reduced.

The movable member is typically in the form of a rod with a length of 40 mm and a diameter of 6.35 mm provided with the disk 11, which has a diameter of 20 mm and a thickness of 1 mm.

The movable member 1 is mainly of stainless steel.

The movable member 1 comprises a ferromagnetic part 9 (preferably a magnet, preferably a permanent magnet) located inside the coil or solenoid or electromagnet and arranged to move inside the coil or solenoid or electromagnet in the principal degree of freedom in translation.

A current amplifier used for controlling the actuator 4 is a Maxon Escon 50/5 module.

A third embodiment of device 103 according to the invention implementing a method according to the invention will now be described, with reference to FIG. 4, but only with respect to its differences relative to the second embodiment 102.

The elements 3, 5, 6, and 9 are not illustrated in FIG. 4 but are present in this embodiment.

The at least one degree of freedom does not comprise any degree of freedom in rotation.

In this version with the rotation blocked, the guiding means 2 comprise two air bearings 2a, 2b.

These two bearings 2a, 2b are arranged for guiding the movement of member 1 along two axes parallel to one another and therefore in one and the same direction so as to block any rotation about this direction.

The actuator 4 is positioned between the two bearings 2a, 2b.

This positioning of the actuator 4 prevents cantilever phenomena. The directions of the forces are aligned.

Comparing the embodiments in FIGS. 3 and 4:
the version with rotation blocked (FIG. 4) has a greater mass and therefore a less favourable ratio of the resolution of the position measurement to the force measurement,
the freely rotating version (FIG. 3) reduces the mass of the device according to the invention.

Thus, the freely rotating version (FIG. 3) is preferred. A second advantage of this version (FIG. 3) is simplification of the mechanics and of the number of elements used.

A fourth embodiment of device 104 according to the invention implementing a method according to the invention will now be described, with reference to FIG. 5, but only with respect to its differences relative to the second embodiment 102.

The elements 5, 6, and 9 are not illustrated in FIG. 5 but are present in this embodiment.

Each actuator 4 comprises or consists of an electromagnetic actuator, and comprises at least one “voice coil”.

The device 104 only comprises one actuator 4 per degree of freedom in translation.

The actuating force 7 has as many components orthogonal to one another (three) as the movable member 1 has degree(s) of freedom in translation.

The guiding means 2 comprise, for each degree of freedom in translation, means for guiding the movable member 1 along at least one axis of translation, more exactly for each degree of freedom in translation considered:
means for constraining the movement of the movable member 1 along a single axis of translation, if the degree of freedom in translation considered is associated with a degree of freedom in rotation about this single axis of translation (the case of the degree of freedom in translation along X),
means for constraining the movement of the movable member 1 along two different parallel axes of translation, if the degree of freedom in translation considered does not have a degree of freedom in rotation about any axis parallel to the two different axes (the case of the degree of freedom in translation along Y and the degree of freedom in translation along Z).

The position measuring means 3 comprise three optical sensors 3a, 3b, 3c such as described above separating the position measurements according to the three orthogonal axes X, Y, Z.

The concept of this device 104 is implemented to allow simplified extension over several degrees of freedom:
three degrees of freedom in translation, and
a single degree of freedom in rotation.

In practice, device 104 corresponds to the combination:
of embodiment 102 in FIG. 3 for the principal X axis (principal degree of freedom in translation along X and degree of freedom in rotation about X)
with two times embodiment 103 in FIG. 4 for the Y axis and the Z axis (degrees of freedom in translation along Y and along Z without rotation about these axes).

The use of the air bearing 2 generates sufficiently large axial stiffness to cleanly decouple the directions of the forces.

On each bearing 2, 2a, 2b used in the sensor, the radial stiffness is 2 N/μm and the maximum permissible force is 12 N.

It is therefore possible to design a device 104 on three degrees of freedom in translation by varying the orientations along orthogonal directions, the Z axis opposing gravity by using a voice coil 4 capable of compensating the weight carried.

For the two axes Y and Z, rotation is blocked to ensure better operation.

Comparing the embodiments in FIGS. 3 and 5: with embodiment 104 in FIG. 5, degradation of performance appears with increase in the number of axes: the movable portion of the second axis comprises the whole of the first axis, and so on.

Thus, the version in FIG. 3 will be preferred, unless measurement over several degrees of freedom in translation is necessary.

Of course, the invention is not limited to the examples which have just been described and numerous adjustments can be made to these examples without exceeding the scope of the invention.

Of course, the various features, forms, variants and embodiments of the invention can be combined with one another in various combinations, provided that they are not incompatible or exclusive of one another.

1. Device (101, 102, 103, 104) for measuring force, comprising:
a movable member (1),
means (2) for guiding the movable member within at least one degree of freedom,
position measuring means (3) arranged for measuring a position of the movable member within the at least one degree of freedom,
at least one actuator (4), different from the guiding means, and arranged for exerting an actuating force (7) on the movable member within the at least one degree of freedom,
a control system (5), arranged and/or programmed for sending a control signal to the at least one actuator, the actuating force depending on the control signal, the control system being arranged for modifying the control signal as a function of a measurement of position of the movable member by the position measuring means,
force measuring means (6) arranged and/or programmed for supplying, based on the control signal sent by the control system to the at least one actuator, a value of a force to be measured (8) acting on the movable member and separate from the actuating force,
characterized in that the means for guiding the movable member within the at least one degree of freedom do not exert a restoring force on the movable member within the at least one degree of freedom.

2. Device according to claim 1, characterized in that the control system is arranged and/or programmed for controlling the position of the movable member at a fixed position regardless of the value of the force to be measured.

3. Device according to claim 1, characterized in that the control system is arranged and/or programmed for fixing a value of the actuating force as a function of the position of the movable member.

4. Device according to claim 1, characterized in that the guiding means are guiding means that are contactless with respect to the movable member.

5. Device according to claim 1, characterized in that the position measuring means are measuring means that are contactless with respect to the movable member.

6. Device according to claim 1, characterized in that the position measuring means do not exert a restoring force on the movable member within the at least one degree of freedom.

7. Device according to claim 1, characterized in that each actuator does not come into contact with the movable member.

8. Device according to claim 1, characterized in that the movable member does not come into contact with any other component of the device.

9. Device according to claim 1, characterized in that it comprises one actuator per degree of freedom in translation.

10. Device according to claim 1, characterized in that the at least one degree of freedom only comprises a single degree of freedom in translation.

11. Device according to claim 1, characterized in that the at least one degree of freedom only comprises a single degree of freedom in rotation.

12. Device according to claim 1, characterized in that the at least one degree of freedom does not comprise any degree of freedom in rotation.

13. Device according to claim 1, characterized in that the guiding means comprise or consist of air cushion guiding means.

14. Device according to claim 1, characterized in that the position measuring means comprise or consist of an optical sensor.

15. Device according to claim 1, characterized in that each actuator comprises or consists of an electromagnetic actuator, preferably of the “voice coil” type.

16. Method for measuring force, comprising:
guiding, by means of guiding means (2), a movable member (1) within at least one degree of freedom,
measuring the position of the movable member within the at least one degree of freedom by means of position measuring means (3),
exerting an actuating force (7) on the movable member within the at least one degree of freedom, by means of at least one actuator (4) different from the guiding means,
sending, by means of a control system (5), a control signal to the at least one actuator, the actuating force depending on the control signal, the control system modifying the control signal as a function of the position measurement of the movable member by means of the position measuring means,
a force measurement supplying, based on the control signal sent by the control system to the at least one actuator, a value of a force to be measured (8) acting on the movable member and separate from the actuating force,
characterized in that the means for guiding the movable member do not exert a restoring force on the movable member within the at least one degree of freedom.
